(19) United States
(12) Patent Application Publication
(10) Pub. No.: US 2011/0320224 A1
(43) Pub. Date: Dec. 29, 2011

(54) Systems and Methods for Customizing Product Selections Based on Member Parameters and Providing the Selections to Members for Purchase

(76) Inventors: Abir Sen, Minneapolis, MN (US); Jill Kristin Prevost, Minneapolis, MN (US)

(21) Appl. No.: 12/824,751

(22) Filed: Jun. 28, 2010

(51) Int. Cl. G06Q 40/00; G06Q 30/00; G06Q 10/00

(52) U.S. Cl. 705/4; 705/322; 705/26.7

(57) ABSTRACT

The present disclosure relates to systems and methods for identifying at least one health plan option for an individual or employee, where the health plan option(s) identified have been selected based on the unique characteristics and profile of the individual or the unique characteristics and profile of the employee and format selections of the employer. The health plan option(s) identified may also be based on criteria provided by the individual or the employer, such as for instance, the amount of deductible and/or premium the individual is willing to pay, or for example, the health insurers the employer has selected to provide employee group coverage.

### FIELD OF THE INVENTION

The present disclosure relates to systems and methods for assisting a user in procuring a health care product or insurance product. More specifically, the present disclosure relates to web-based systems and methods for identifying at least one health plan option for an individual or employee, where the health plan option(s) identified have been selected based on the unique characteristics, profile, and personal preferences of the individual or employee. The health plan option(s) identified may also be based on criteria provided by the individual or the employer, such as for instance, the amount of deductible and/or premium the individual is willing to pay, or for example, the health insurers that the employer has selected to provide employee group coverage.

### BACKGROUND OF THE INVENTION

The cost of health care in the United States is extraordinarily and notoriously expensive. Many aspects of the U.S. health care system contribute to its expense. For example, some factors include: the mixture of public and private payers; the lack of connection between what a typical insured person pays in premiums/deductible and/or co-pays and the services the person may receive; the enormous amount of medical innovation that occurs and the associated regulations for new drugs and/or devices; and the overall complexity of the system in general, which leads to administrative costs that continue to sky-rocket.

A large portion of the U.S. population has employer-based health insurance. An employer may offer health insurance as a benefit to its employees, and in some cases may ask the employee to contribute some amount per year for the employee's coverage. Often times the employer may select one or more plans its employees may choose from—typically this is a small number of plans, between 1 and 3, in many cases. The process of selecting a health insurance carrier and specific plans may be very complicated and time-consuming for the employer. Many times, all of the relevant information may not be available to the person or people at the company making the decision. Consequently, a company may end up with a carrier and/or plans that are not cost-effective and that may not be a good fit for some or all of the company's covered employees.

Other U.S. citizens may be unemployed—or employed by an employer that does not offer health insurance—but may be ineligible to receive public forms of health insurance, for example Medicare, Medicaid, or COBRA. Consequently, the individual must purchase health insurance individually on the market, if they want health insurance coverage at all. This may be a daunting task for people unfamiliar with the complicated, heavily regulated, and ever-changing world of health insurance. An individual may wish to compare different products to determine the product that may be best suited to the person's needs and situation but may not have the time, information, knowledge, and/or means to research and compare available products.

Accordingly, a need exists in the art for an easy-to-use, intuitive, comprehensive system that may be used by employers/employees and/or individuals in order to provide the user with at least one health insurance product that is selected based on the user's unique personality, personal preferences, health profile, and/or financial profile, whereby the user may choose to purchase one or more of the selected products.

### BRIEF SUMMARY OF THE INVENTION

The present disclosure in one embodiment relates to a method for identifying a product for purchase by an employee based on the employee's circumstances and preferences. The method includes providing a secure web-based system that allows an employer of the employee to register with the system. The method further allows the employer to make format selections related to a category of product that the employer makes available to the employee via the web-based system, wherein one of the format selections comprises the amount of money the employer will commit to an employee account set up on the web-based system in order for the employee to purchase an identified product. The method also includes allowing the employee of the employer to register with the web-based system. The method further includes administering a survey via the web-based system to the employee. The method also uses the results of the survey for the system to identify at least one product that meet criteria of the employee as established by the results of the survey and that meet criteria of the employer as established by the format selections made by the employer. The method also provides permitting the employee to select an identified product for purchase that may be paid for by the system via the employee account or via a combination of funds from the employee account and the employee's personal funds as appropriate.

In another embodiment of the present disclosure, a method is provided for providing for purchase by an individual at least one health care product that has been specifically selected for the individual. The method includes administering a web-based survey to the individual, the survey providing questions related to at least one of the individual's personality profile, financial profile, or health status, wherein the results of the survey are saved and stored in the web-based system. The method further includes using the results of the survey as input for the web-based system to run a recommendation engine, wherein the recommendation engine selects at least one health care product for the individual based on at least one attribute of the health care product matching at least one result provided by the individual in response to the survey. Also included in the method is paying for a health care product selected for purchase by the individual from funds deposited in the account of the individual via the web-based system or the individual's personal funds as appropriate.

In yet another embodiment of the present disclosure, a web-based system is provided for providing at least one identified health insurance product or service for purchase by an employee of an employer where the at least one product or service fits criteria provided by the employee and the employer. The system includes a client format selection module permitting an employer to provide the system with format selections, including how much money to deposit into an employee account in order for the employee to purchase a health insurance product via the system. The system also includes an intelligent assessment survey module that administers a survey to the employee to determine the employee's preferences and circumstances related to health insurance. The system also includes a recommendation engine module in communication with the intelligent assessment survey module configured to use results of the survey to provide the employee with at least one health insurance product or service for purchase where the at least one identified product or service is based on the results provided by the employee in the survey and format selections provided by the employer.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a diagram generally showing the process used to employ the systems and methods of the present disclosure, according to one embodiment.

FIG. 2 is a flow diagram illustrating some of the modules present in some embodiments of the present disclosure.

FIG. 3 shows the HIS system operating in a cloud computing environment, according to some embodiments of the present disclosure.

FIG. 4 provides some examples of parameters and associated tags used in some aspects of the present disclosure, according to one embodiment.

FIG. 5 shows a flow diagram describing the process used to employ the systems and methods of the present disclosure, according to one embodiment.

### DETAILED DESCRIPTION

The present disclosure relates to novel and advantageous systems and methods for identifying at least one health plan option for an individual or employee, where the health plan option(s) identified have been selected based on the unique characteristics, profile and/or personal preferences of the individual or employee. The health plan option(s) identified may also be based on criteria provided by the individual or the employer, such as for instance, the amount of deductible and/or premium the individual is willing to pay, or for example, the health insurers the employer has selected to provide employee group coverage.

More specifically, the present disclosure relates to web-based systems and methods for matching individuals or employees—whose employers are part of the system—with health insurance plan options that may be uniquely selected for the individual or employee and may accordingly be more appropriate and cost-effective than prior art “one size fits all” methods of selecting and obtaining health insurance.

While specific embodiments and features of the present disclosure will be provided in detail below, a general description of the present disclosure, in some embodiments, will now be provided. It will be recognized that the following general description may include some steps or features that may not be included in some embodiments, while some steps or features may be included in some embodiments that are not provided in the following general description. For ease of explanation, the following general description will be provided with regard to an employer and employee using the systems and methods of the present disclosure, but it should be understood that the description is not limited to employer/employee clients.

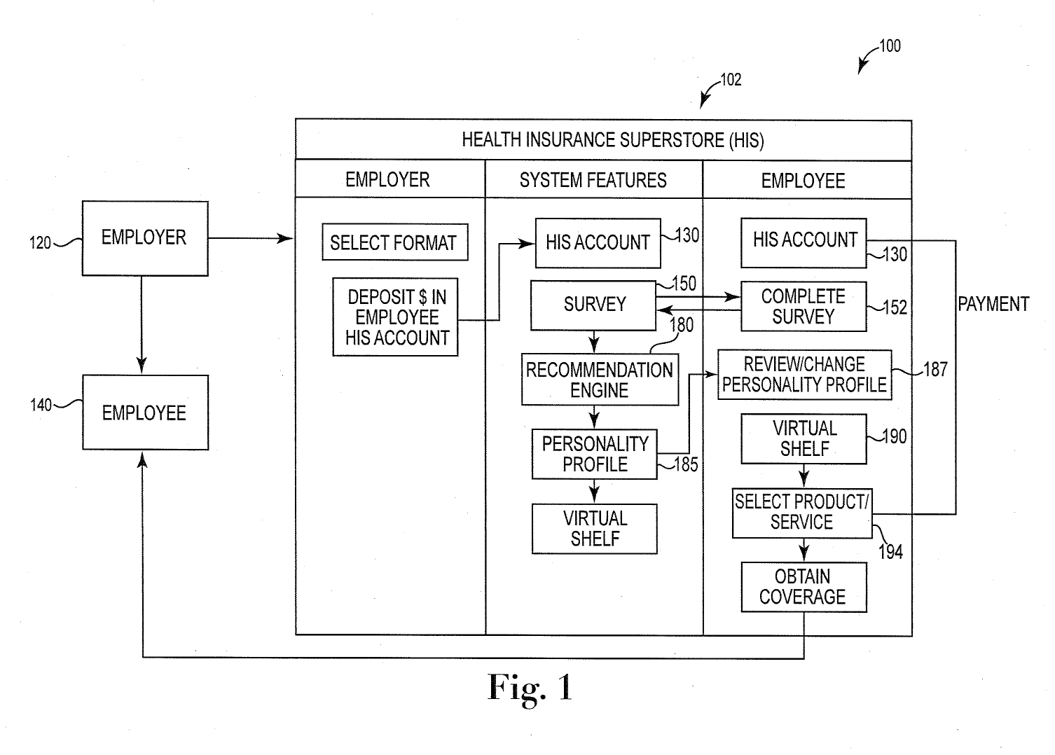

Generally, a web-based system for providing health insurance and/or health care solutions may be provided. With reference to FIG. 1, the web-based system may generally function as an on-line health insurance superstore (hereinafter referred to as “HIS”) 102. The HIS 102 may have initial clients and in some cases secondary clients. One example of an HIS 102 initial client may be a company 120, for example. The company 120 may wish to provide its employees with health insurance and may have elected to use the HIS 102 to accomplish this. The HIS 102 may provide the employer 120 with HIS 102 features, tools, and/or services to help the company determine how much money in pre-tax dollars, for example, to allocate to each of its employees for the purchase of health insurance. In some cases, this may be the same amount of money for each employee, while in other cases the amount of money allocated to each employee may vary according to certain criteria that will be explained in greater detail below.

Once the employer 120 determines the amount of money to allocate for each of its participating employees, the employer may commit pre-tax funds equal to that amount into an account 130 for each of its participating employees. The employee 140 may be considered a secondary client of the HIS. The employee 140 may have access to the HIS account 130 via the HIS system web site. The employee 140 may access the secured on-line HIS system 102 in order to select a specific health insurance plan that may be paid for out of the employee's account 130. In order for the HIS 102 to identify appropriate and optimal health insurance plans for the employee 140, the HIS 102 may request that the employee 140 complete a survey 152 generated by the HIS. In some embodiments, the survey 150 may be a comprehensive, intelligent and friendly health and financial assessment that may help the HIS 102 identify appropriate health plans and services for that employee 140.

The employee's 140 responses to the survey 150 may be used as inputs that may be used in the HIS 102 recommendation engine module 180. The HIS may also use the outputs of the survey 150 to provide a personality profile 185 via a personality profile module of the HIS. The employee 140 may review the personality profile 187 and assess whether or not they have been accurately characterized. If the employee 140 does not think the personality profile accurately describes them, they may be asked by the HIS to retake some or all of the survey. The personality profile module of the HIS may generate a revised personality profile based on the employee's new responses to the survey. If the employee 140 agrees that the revised personality profile accurately describes them, the revised outputs from the survey may be used to run the recommendation engine 180 again. The recommendation engine 180 may return as output, specific health care plans and/or services that match or meet the parameters identified by the employee 140 in the survey 150. The health care plan options identified by the recommendation engine 180 may then be provided to the employee 140 at the HIS 102 via a “virtual shelf” user interface 190 that may clearly and simply provide and/or explain the uniquely identified health care plans and/or services identified by the recommendation engine 180 for that employee 140.

The employee 140 may review the health care plan options and information provided by the virtual shelf module 190. The employee 140 may use the information provided to select a health care plan and/or service 194 that best suits the employee. Payment for the selected plan may come from the employee's HIS account 130. In some cases, the employee 140 may select a plan that costs less than the amount of money in the employee's HIS account. An employee may access the HIS 102 to shop for other available products and/or services on which the employee may spend the remaining money. The HIS system may administer and oversee the entire transaction.

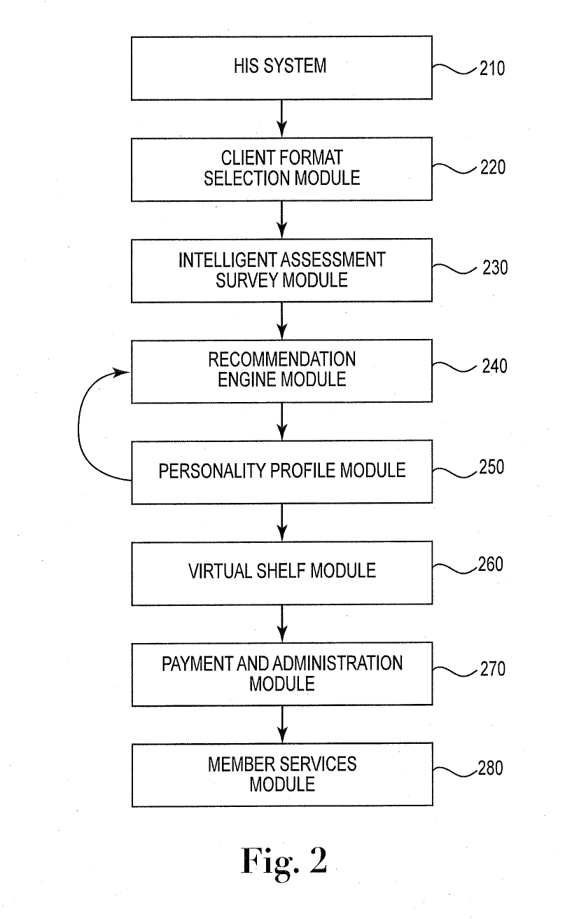

As shown in FIG. 2, in some embodiments the HIS 102 system may comprise some or all of the following modules: HIS system 210; client format selection module 220; intelligent assessment survey module 230; recommendation engine module 240; personality profile module 250; virtual shelf module 260; payment and administration module 270; and/or member services module 280. Each of these modules or components thereof, may include software or a portion thereof, hardware or a portion thereof, or a combination of software and hardware. It is also noted that each module or component thereof may be combined or overlapped with or combined with modules or components performing other tasks in the process. In some embodiments, this overlap or combination may include tasks or steps adjacent to one another in a process, but in other embodiments, the tasks and steps may not be adjacent one another. Moreover, any module or component thereof may or may not be included in the system depending on the nature of the system desired. Additionally, the HIS system or any module or component thereof may include an input and output module adapted to receive or send information from or to, respectively, other devices, modules, or components. As such, these input and output modules can include physical ports or connection to a bus where the input or output module is of the hardware type. Other types of input and output hardware may be used. In the case of software based input and output modules, these may include lines of code causing a processor to step or jump from one location to another or to an application programming interface, for example. Other types of software based input and output may also be used.

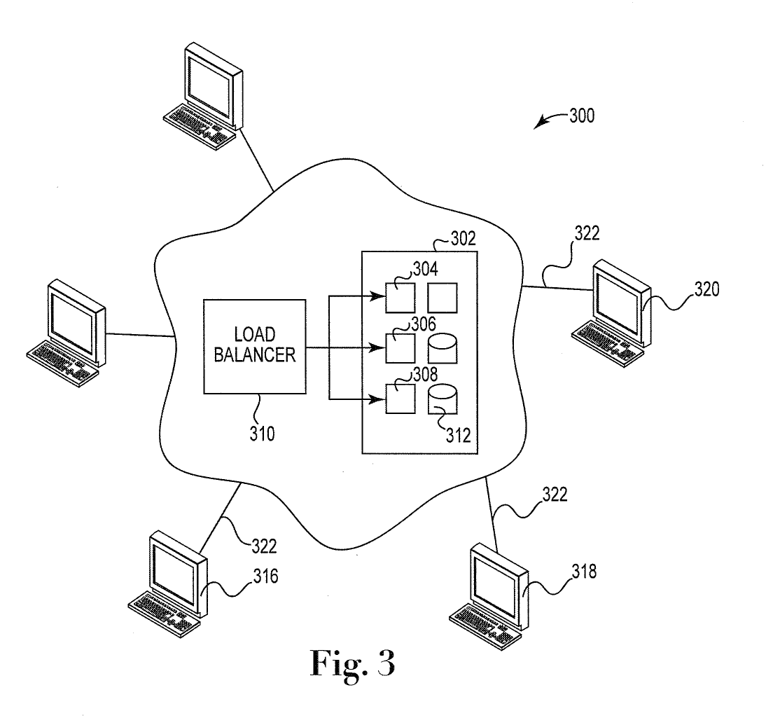

With reference to FIG. 3, which will be described in greater detail below, in the case of a module where all or a portion of the module is software, the software may be located, for example, in the database 312 for access by the HIS application server(s) 304, 306, 308. In other embodiments, the HIS application server(s) 304, 306, 308 may include the software. Those of skill in the art will understand and appreciate the several configurations available for using software, hardware, or a combination thereof to provide a module.

Each of the modules will be discussed in turn below under headings referenced in FIG. 2.

### HIS System 210

The HIS system may include, in some embodiments: system components; member introduction components; and product components.

The system features of the HIS 102 system may include the general HIS web-based platform. In some embodiments, the HIS 102 may be a web-based system that may be made available to clients or members over the internet. In one embodiment, the web application may be developed using Groovy, Grails, Linux and MySQL technology. The application may, in some embodiments, use the Grails scaffolding, for example. In other embodiments, however, the web application may be developed using any known technology and/or computer language.

In some embodiments, the HIS may be run and offered via a cloud computing environment. Cloud computing generally refers to internet-based computing, whereby shared resources, software and information may be provided to computers and other devices on-demand, similar to utility services, allowing for dynamically scalable and often virtualized resources as a service over the internet. In some cases, for example, a cloud computing provider may deliver the HIS system online such that it may be accessed from another web service or software such as a web browser, while the software and data may be stored on servers. The cloud computing infrastructure may be delivered through data centers built on servers. Cloud computing may typically involve cloud components that communicate with each other over application programming interfaces, usually web services.

With reference to FIG. 3, in some embodiments, the HIS may be provided via a cloud-based computing system 300. The HIS application may be designed to run in a virtualized environment 302, for example Amazon's EC2 platform. The virtualized environment 302 may host a plurality of virtual machines 304, 306, 308. In some cases, one or more machines 304, 306, 308 may include a full Linux operating system (OS). In some embodiments, these operating systems may be running Tomcat, for example, as an application server. A load balancer 310 may also be included in the system 300 such that the work load is efficiently and effectively spread across multiple application servers 304, 306, 308. In some embodiments, the load balancer may be a HAProxy load balancer. The system may also include one or more databases 312 for safely and securely storing data. In some cases, the database may be a MySQL database. While specific products and applications have been described with regard to the virtualized environment, application servers, load balancer and database, it will be understood that the use of alternative products and applications is within the spirit and scope of the present disclosure.

A member may use a personal computer 316, 318, 320 to access the HIS system via the internet 322. The web-based HIS system may be accessed by any number of members simultaneously via individual personal computers 316, 318, 320. The HIS web-based system may be generally similar in concept and structure to other well known and understood web-based systems, providing a user with user-friendly web pages and applications, for example.

Some pages of the HIS web site may be generally accessible to the public, such as, for instance, the home page, and other pages that may provide general information about the system. The site may also include areas that are password protected or otherwise secured, so that members or clients may provide and/or receive information, including confidential information, in a safe and secured manner. Any known method of providing secured access to the web site or portions of the web site may be used.

In some embodiments, different modules, components, portions, features, or aspects of the HIS system 102 may be made available to users depending on the role or status the user may be associated with. For instance, a user may be designated as an administrator, product manager, member services representative, employer human resources representative, or a member, for example. The role associated with a user may limit or expand the areas of the HIS system the user may have access to, depending on the security level assigned to the designated role.

The HIS system features may also comprise user-friendly interfaces. For example, user's who are designated as members may find the following tabs, links, or pages, available to them on the HIS, for example, but not limited to: “Create Your Account”; “All About Us”: “All About You”; “Your Options”; “Your Account.” The web site may also include links to legal information that may be general and available for all users to review or that may be tailored for users with different roles or statuses. Legal information that may be provided on the site may include, for example, but is not limited to: terms of use; terms of service; privacy policy; terms and disclaimers; data types collected and disclosed; Health Insurance Portability and Accountability Act (HIPAA) information and requirements, and/or any other relevant or necessary legal information.

In some embodiments, the HIS web site may include a member feedback area, a member ratings area, and/or a community area, for example. The HIS may also provide any other member areas on the web site that may provide useful information and/or services for its members.

The HIS system may also comprise a member introduction feature. A new member may, in some embodiments, receive an email, for example, that may direct them to a URL and token to register on the HIS. In other embodiments, the information may be provided by standard mail, or may be delivered to an employee by their company, for example. In some embodiments, the first time a new user attempts to register with the system, the user may be directed to a feature on the site to assist the user in registering and signing-in to the system as a member. In some embodiments, a welcome or orientation module may be presented to the new user.

In some cases, the new user may be a company or employer who has decided to use the HIS system to allow its employees to select health care plans individually. There may be many users associated with the company or employer with a variety of different roles. For example, the company may have a number of administrators and/or human resources representatives, for example, designated as company-level members. As discussed above, depending on the role of the member, each user or group of users may have different levels of access to modules, components or features of the HIS system. In other cases, the new user may be an employee of the employer. While in still other cases, the new user may be an individual using the HIS system to purchase health insurance directly from the HIS system, i.e. not as an employee of a company using the HIS system. Depending on who the new user is, the new user orientation and/or welcome may vary to provide information relevant to the type of user accessing the system.

The HIS system may also include product features that may generally define the products and/or services the HIS may make available to clients or members. In some embodiments the products and/or services may include all available plan types, and provide the brokering.

As discussed above, in one embodiment, the HIS may offer products/services directly to individuals, i.e. who may not be employed by an HIS member. In other embodiments, the HIS may provide products and services to employers that may ask its employees to use the HIS system to select a health insurance plan, for instance.

In some embodiments of employer-based embodiments, the HIS system may allow employers to include only full-time employees in the HIS system. In other embodiments, the HIS may offer employers formats that may include, or may also include, part-time employees. In some embodiments, the HIS system may offer employers formats that may include, or that may also include, former employees under, for example, a Consolidated Omnibus Budget Reconciliation Act (COBRA) alternative.

In some embodiments, the HIS may allow member companies to add new employee members at any time during the month or year, for example. In other embodiments, the employer may only be able to add new employees at pre-determined and specified times. In other embodiments, the HIS may allow member companies to remove employee members at any time during the month or year, or in other embodiments, employee members may only be removed at pre-determined and specified times.

Once the employer has determined which employees may be participating in the HIS system, the employer may be asked to provide the HIS with a census file containing relevant employee information. Such information may include, but is not limited to: email; first and last name; date of birth; employer number; address; phone number; social security number; marital status; and date of hire. The employee information may be entered into the HIS system either automatically or manually, in some embodiments. In some embodiments, a company's human resources representative may directly upload the census file, for example, in an Excel spreadsheet format, to the HIS system. In another embodiment, a standard 834 (benefits and enrollments form) that the company may have on file for each employee may be, for example, uploaded to the HIS system. Similarly, the company may upload, or otherwise provide the HIS with other relevant changes to an employee member's status, for example, whether a member employee's employment status changes, or marital status changes, for example.

The HIS may categorize different plan types according to the following market segments, in some embodiments: defined contribution for a group of more than fifty; defined contribution for a group of less than fifty; defined contribution for an individual; COBRA, for example. The HIS, in some embodiments may coordinate the underwriting process, which may be affected by the market segment the member belongs to, which in turn may affect the health insurance plan or plans that may be available to the member.

The HIS, in some embodiments, may function as the broker of record for direct sales of health insurance plans. In other embodiments, the HIS may partner with a third party broker in order to, for example, provide information to clients related to, for example, but not limited to: defining contribution strategy; conducting carrier selection/renewal; determining plan design; conducting open enrollment meetings; and/or providing customer support and on-going value-added broker services. In some embodiments, the HIS as broker or a third party broker may solicit quotes from health insurers or carriers and may also coordinate underwriting for group coverage and/or individual coverage, for example.

While the HIS in some embodiments may coordinate underwriting, but not directly provide underwriting, a general description of the underwriting process is provided. Generally, medical insurance underwriting is a formal process through which major medical insurance companies evaluate the risk of possible financial loss if coverage is extended to a single individual or group.

There are several risk factors that medical insurance companies may consider in their underwriting criteria for individuals such as age, health status and history, occupation, hobbies, risky behaviors, and lifestyle. Typically, an application that will be reviewed by the underwriter may be completed.

Individual underwriting typically does not take place in the same way for those enrolled in group coverage, such as that through an employer, union, or association. Under a group policy, only a short application may be completed that may include, for example, name, address, Social Security number and whether there are any dependents that will also be covered. The insurance underwriter may consider the number of people covered on the policy and the type of work being performed as underwriting guidelines. Often, individuals joining an insured group must serve a probationary period before becoming eligible for coverage and then they may enroll during the eligibility period; often call “Open Enrollment.”

If medical insurance is provided through an employer, COBRA coverage may be available to an employee should employment end voluntarily or otherwise, provided the employer has twenty or more employees, according to current law. COBRA members may not be subject to individual underwriting.

### Client Format Selection Module 220

Once an initial member has registered with the system, the member may make format selections by using the client format selection module of the HIS system. In some embodiments, the initial member may be an individual not associated with a member company that wishes to purchase health care directly using the HIS. Such embodiments will be described in greater detail further below.

In other embodiments, the initial member may be a company. The company may make certain format selections, such as for example, but not limited to, whether to extend coverage to full-time, part-time, and/or former employees. The company may also determine how much of a defined contribution the company wishes to make to the account of each participating employee. The amount of money allocated to each employee may vary from employee to employee based on a number of factors. In other embodiments, each employee may be allocated the same amount of money. The company may utilize products and/or services provided by the HIS to help the company determine an appropriate amount of money to allocate to each employee or group of employees.

In some cases, an employer may choose to set up Health Reimbursement Accounts (HRA) for its employees via the HIS. HRAs are Internal Revenue Service (IRS)-sanctioned programs that allow an employer to reimburse medical expenses paid by participating employees, thus yielding tax advantages to offset health care costs. The employer may allow for any credit balance in an employee's account to be rolled over from year to year like a savings account. The employer may also choose how much of any balance rolls over, which can be either a flat amount or a percentage, for example.

With an HRA, employees may be reimbursed tax free for qualified medical expenses up to a maximum dollar amount for a coverage period, for example, copays, coinsurance, deductibles and/or services. HRA dollars may generally be used to cover medical, dental, and vision expenses. The employer may determine what expenses that meet IRS 213(D) may be included in the HRA plan.

The HIS format may also include allowing the employer to set up employee accounts that are limited HRAs which may be used to pay or reimburse benefits for permitted insurance and/or permitted coverage other than long-term care, and preventive care. In one embodiment of a limited HRA, the funds from the account may be limited by the employer and/or the HIS to pay for reimbursement of individual health insurance policies for example. Or the limited HRA may be limited such that if any money remains in the account after payment of or reimbursement for health insurance premiums, the employee may purchase additional products available on the virtual shelf or use a reimbursement mechanism for dental, vision, and preventative care expenses, for example. In another embodiment of accounts that are limited HRAs, the limited HRA may be used to pay for health insurance premiums for a high deductible health plan such that availability and eligibility to also use a health savings account is preserved under the tax code. In such a case, the use of the limited HRA may be limited to paying for premiums for high-deductible plans.

In embodiments where an employer sets up HRAs for its employees via HIS, the HRA dollars may be allocated, for example, based on the coverage tier of the member employee. For example, coverage tiers may include: the employee only; the employee plus one; the employee plus family, for example. Eligible dependents may be defined by the employer for groups greater than fifty, in some embodiments. For groups less than fifty, eligible dependents may be defined by the state, in some instances, while in other instances, for example, eligible dependents may be defined within each product. In some embodiments, a cap on the amount of money that may be in each HRA account may be determined by, for example, the employer, or the sponsor of the plan each individual purchases.

In other embodiments, an employer may choose to set up a Wellness Education Account (WEA) as part of the employer selected format. WEA accounts may be separate and different than an HRA, in some embodiments. A WEA plan may generally be in writing and operate much the same as an HRA, but may be subject to an annual limitation of, for example, $5,250. WEA funds, in some embodiments, may roll over from year to year. Education may be provided by the employer directly, in some embodiments, or may be provided in other embodiments, for example, by a third party. The education may include, in some embodiments, online, telephone, and/or in-person delivery methods. WEAs may be additionally subject to non-discrimination requirements. In some embodiments, employers may only include current or former employees in a WEA plan. There may also be, in some embodiments, prohibitions on benefits for certain 5% owners, for example. In some embodiments, WEA funds may be used for eligible dependents covered in a health insurance plan.

In some embodiments, employers may also select a Premium Only Plan (POP) or a Premium Reimbursement Account (PRA) that may allow the employee to be reimbursed for premium payments paid with employee pre-tax dollars that are deducted from the employee's pay, if for example, an individual exhausts the funds in their HRA HIS. The HIS may, in some embodiments, calculate the payroll deduction amount and create a report for the company such that the company may appropriately adjust the employee's pay.

The HIS may, in some embodiments, be integrated with a member company's payroll such that the HIS may automatically adjust a member employee's pay based on, for example, insurance premiums paid via a POP that may be serviced by the HIS.

The HIS may offer an employer one or more standard plans, for example. In one embodiment, a standard plan may include an employer setting up HRA HIS accounts for each participating employee. The employee may use the funds in the HIS account to purchase, for example, insurance products and/or IRS 213D eligible products. A standard plan may also include, for example, a WEA that may be used separately from an HRA, for example, and may be used to pay for educational or activity programs. For example, in some embodiments, the programs may include nutrition programs, nutrition tracking programs, general health monitoring programs, fitness log and advisor, or any other suitable health and wellness oriented program. In such an embodiment, for example, the HRA HIS account may function substantially similarly to the WEA HIS account.

In one embodiment, a standard plan may only include the HRA HIS account, while in other embodiments, a standard plan may include a WEA HIS account, or in other embodiments, a standard plan may include both an HRA and a WEA HIS account.

In some embodiments, the company may also choose certain options with regard to mid-year hires. For example, whether the mid-year hire receives a direct contribution equal to the amount for the full year, or whether the mid-year hire receives a pro-rated portion of the full year's direct contribution. Contributions may be pro-rated in some embodiments depending on the month the employee was hired, for example, or in other embodiments, at the beginning of a fiscal quarter. In still other embodiments, pro-rating may be done by any reasonable method.

Similarly, in some embodiments, an employer may choose options related to employees whose tier status changes during the year. For example, a married employee may have a child during the year and accordingly the employee's tier status may change from employee plus one to employee plus family, for example. The company may choose whether the HRA and/or WEA contribution amount may be increased to the full amount of the new coverage tier less payments already paid, for example, or whether the HRA and/or WEA contribution amount may be increased on a pro rated basis, for example. A decrease in coverage resulting from a change in employee tier status, in some embodiments, may not result in a decrease in HRA or WEA HIS dollars for the year.

Further, in some embodiments, a company may choose the amount of time, for example, a number of days, or through the plan year, that the funds in an HIS HRA and/or WEA account may be held for an employee for them to return to the same account balance, for example when an employee leaves the member company.

The HIS and/or the company may also make available to members, products other than those discussed above, in some embodiments. For example, some or all of the following options may be made available to some or all members: vision; life insurance; voluntary life insurance; short-term disability; long-term disability; business travel accident; accidental death and dismemberment; flexible spending accounts (which may include transit, medical, and/or dependent care); health savings accounts; and/or long term care, and/or any other ancillary benefit. While embodiments described herein are described and explained with regard to health insurance and/or wellness products, it will be recognized that the HIS system may be used in a substantially similar manner to provide a member product options from the aforementioned categories as well.

The company's selections and choices may be entered and stored in the HIS. Once the company has made all of the required and/or available formatting decisions as described above, the company may instruct its participating employees to access the HIS system. The employee member may register with and/or be welcomed to the HIS as described above.

### Intelligent Assessment Survey Module 230

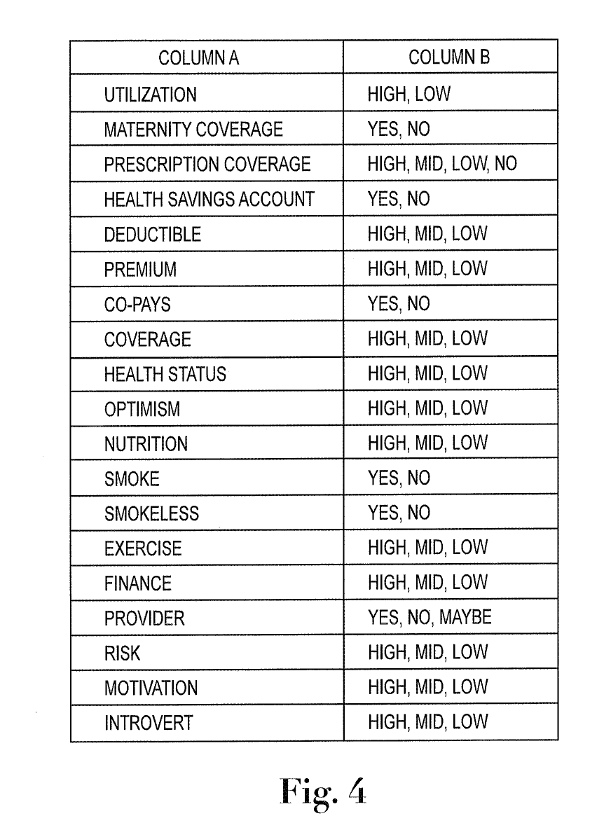

The HIS, in some embodiments, may include an intelligent assesment survey module that may be used to administer to the newly registered employee, an intelligent assessment survey (IA). The IA may be a survey that includes a plurality of questions. The questions may be of any form and/or format, for example, but not limited to, fill in the blank, short answer, multiple choice, true or false, rating/ranking and/or any other form or format of questioning. The IA may have any suitable number of questions, for example, in some embodiments, the IA may have approximately thirty questions. It will be understood, however, that the IA may have any number of questions greater or less than thirty. In some embodiments, the questions may be asked in a fun, engaging way. The questions may be directed to the employee member's health, behavior, personality, and/or financial situation, for example. In some embodiments, the questions asked may vary depending on the attributes of the member employee, for example, but not limited to the age, gender, and general over-all health of the member. Column A of FIG. 4 provides some examples of categories of questions that may be asked about in the IA.

The IA may be administered on-line in the HIS, in some embodiments. In other embodiments, the IA may be a paper and pencil survey that may be mailed to the HIS by the employee or the company for input into the HIS system.

### Recommendation Engine Module 240

The member's responses to the IA may be used by the HIS to run the recommendation engine module. For example, in some embodiments, similar to the way the PP module works with the IA, which is described in detail below, each response to the IA may be assigned a dimension and tagged with a label such that the member's preferences and needs may be matched most appropriately with the eligible products offered by the HIS. Examples of labels that may tag a particular dimension are provided in Columns A and B of FIG. 4. In some embodiments, each IA response provided may have one or more tags associated with it that may describe the response for purposes of use with the recommendation engine module. In some cases, the tags associated with IA responses for use with the PP module may be the same as tags associated with the same IA responses for use with the recommendation engine. In other cases, a single response may have one tag associated with it for use with the PP module, and another tag associated with it for use with the recommendation engine module.

Each eligible health care product may also have one or more tags associated with it that describe the product with regard to a particular dimension. For example, a product may have tags associated with it as follows: risk-low; smoke-yes; finance-high. The recommendation engine may provide product options for the member by sorting the products by the number of tags that match between the member's responses and the tags associated with the product, for example. For example, in some embodiments, products with the tag that occurred most often in the user's responses may be sorted above those that do not have that tag. If more than one available product has that tag, the recommendation engine may look at the member's second most selected tag and so on through the list of the member's remaining tags. If there are no more tags to review, but a product has not been found to be a best match for a member, the recommendation engine may sort on the price, sorting, for example, lower priced products before higher priced products.

The recommendation engine advantageously may only select those products that are 1) available to the employee for purchase (based on, for example, the employer's format selections), and 2) best suited to the personal preferences and other attributes of the employee as identified by the IA. Accordingly, an employee is unlikely to purchase a plan that is not well-suited and cost-effective for them. For example, a person that is generally considered “risk-low” may not be best served purchasing a product that is generally a “risk-high” product. The recommendation engine module, in conjunction with the virtual shelf module, help the client choose among the best products available to them based on their own personal preferences and attributes as determined by the IA.

In some embodiments, the recommendation engine may provide as output one or more personalized options for the member to purchase, including, for example, health care insurance and/or wellness education products and/or services.

### Personality Profile Module 250

In some embodiments, the HIS may provide the member with a healthcare personality profile (PP) via the system's personality profile module. The personality profile may comprise an individualized report that may be a summary of the member's unique health personality. The PP may be compiled by the HIS using information provided by the member in the IA. Each of the questions in the IA may have several possible responses (for example as in a multiple choice or true/false formats). Each of the possible responses may have one or more tags associated with each response that may be different from the tags assigned to the other possible responses. For example, a question may ask, “how likely are you to sky-dive in the future?” The possible responses may include: a) there is no way I am ever going sky-diving, b) I would not rule it out, or c) I have a standing monthly appointment at the air field. In this case response “a” may have a “risk-low” tag associated with it; response “b” may have a “risk-mid” tag associated with it; and response “c” may have a “risk-high” tag associated with it. Similarly, each personality statement associated with the PP and stored in the HIS may also have one or more tags associated with it, for example, “risk-low,” “risk-mid,” or “risk-high.” For example, one of the personality statements stored in the HIS's PP module may be the following: “you are an adventurous person who likes to try new things including exhilarating activities that remind you that you are alive.” This PP statement may be associated with the “risk-high” tag.

After a member completes the IA, the HIS system may sum up all of the tags associated with the responses the member has provided and the number of occurrences of each type of tag. Personality statements associated with the tags that occurred most often in the user's responses may be sorted above personality statements that do not have that tag. In the example provided, the hypothetical respondent provided at least one response associated with the “risk-high” tag. If, for example, the hypothetical respondent also selected additional responses with the “risk-high” tag, the HIS may select the personality statement that is also associated with the “risk-high” tag to summarize the personality type of the respondent. A maximum number of personality statements may be provided in the member's PP, for example, four statements, or any other number of statements.

In some embodiments, the member may be asked to confirm the accuracy of the PP. In some cases, if the member does not agree with the PP, the HIS may alter the recommendation engine inputs of the member to conform to the member's feedback regarding the PP. In such a case, the member may be asked to confirm the accuracy of a second, updated PP. If the member confirms the accuracy, the recommendation engine may use the responses from the altered IA to generate a list of products for the employee to consider for purchase. In some embodiments, the member may also retake the IA in order to change their previously entered responses to better conform to their circumstances and/or preferences.

### Virtual Shelf Module 260

The output of the recommendation engine may be used to provide products on the HIS virtual shelf for the member via the virtual shelf module. In some embodiments, one or more products on the virtual shelf may be a health insurance plan. The virtual shelf may display and explain each of the products. For instance, for a health care plan offered on the virtual shelf, the member may be provided with the plan's associated deductibles, riders (e.g. preventative, network, smoking status, prescription coverage), coverage tiers, age bands, prices, or any other factors that may be associated with the product. The employee may be able to select the carrier/offering/product of their choice from the virtual shelf for purchase.

In some embodiments, the virtual shelf may also include wellness education programs and/or services. For example, some of the programs offered may include, online nutrition programs, online food tracking programs, online activity programs, smoking cessation programs, disease management programs, and/or other wellness services. In some embodiments, the wellness products may be free, or they may cost some amount of money, or may include a mixture of both.

### Payment and Administration Module 270

Once the member has selected one or more products for purchase, the HIS may be used to pay for the product and/or service with the funds that have been allocated to the member's HIS account via the payment and administration module. If, for example, the HIS account is an HRA or a WEA account, the HIS system may automatically transfer the correct amount of funds from the sponsor account or accounts to the service provider. In other embodiments, the employee may make the payment directly, but may be reimbursed by the HIS system with funds from the member's HIS account. In some embodiments, the HIS may make a payment to a partner that may cover one or more employees, drawing on funds from one or more accounts. Any payment adjustments that may be made to a member's account may be managed either automatically or manually by HIS, in some embodiments. Any necessary reconciliation and/or adjustment that may need to be made to a member's account may be made at any appropriate time, for example, but not limited to, the following month.

In some embodiments, the HIS and/or the employer may contract with a third party to provide claim adjudication, account management, and payment card services, for example.

### Member Services Module 280

The HIS system may also comprise a member services module. The member services module may be accessible via a tab, for example, on the HIS web site. Some examples of member services that may be available in some embodiments, include, but are not limited to: web site support (including, for example, login issues, navigation, community and message boards, and/or general help); assistance with the member's HIS account (including, for example, balance inquiries, transaction inquiries, payroll deduction issues and questions, and/or member data updates); assistance with completing the IA; assistance with virtual shelf purchases (including, for example, features and pricing, payment process, accessing services on vendor sites, and/or returns and refunds); ranking virtual shelf products and services; connecting to virtual shelf vendors' customer services as appropriate; and/or triage to health insurance enrollment support, licensed representatives or to tier two customer service support for complex account administrative questions, for example.

In some embodiments, the HIS system may provide the member services, while in other embodiments member services may be provided by the HIS and/or plan sponsors, for example. Member services may be provided by any known means, including, but not limited to, telephone, email, in-person, mail, text, live-chat, and/or any other method for communicating with a member, or providing information to a member or prospective and/or past member. In some cases, licensed representatives of the HIS may specifically respond to health insurance questions that the member may have. The HIS may track all customer interactions with members, in some embodiments, for documentation and/or evaluation purposes, for example.

Member services may also include insurance enrollment support for initial selection and/or after a selection has been made, in some embodiments. For example, in some embodiments, member services may include, but are not limited to the following: general health insurance education/assistance (including, for example plan types, financial consideration (e.g. deductibles, co-insurance, co-pay)), coverage considerations (e.g. preventative care, conditions covered, prescription coverage); understanding health insurance options made available by the employer (if applicable); understanding available employer contribution tiers (e.g. single, family, opt out, etc.); support for qualifying events (coverage changes, employer contribution adjustments, COBRA process); connect to a health plan's support center; information on the appeals process for virtual shelf insurance vendors; and/or support for member grievances.

In addition to the member services described, the HIS may also include the following member services directed generally to helping a member understand the products recommended by the HIS, for example, but not limited to: factors used in the recommendation engine; benefits of choosing recommended products; and/or purchasing products outside the recommended set. In some embodiments, the following member services may be offered generally relating to assisting the member with virtual shelf purchases, for example, but not limited to: features and pricing; payment process; accessing services on vendor sites; ranking virtual shelf products; and/or returns and refunds. In further embodiments, member services may include, or may also include, services directed to helping a member make a health plan decision and/or the health insurance enrollment process, including, for example: completing the health insurance enrollment application; payroll deduction set up; and/or other method of payment set up (e.g. credit card, direct deposit, etc.). It will be recognized that still other member services may be included in the HIS in order to assist HIS members, prospective members and/or former members with their health care needs.

In some embodiments, the HIS may also comprise an evaluation process to determine whether a commercially available product, or a specifically designed product has sufficient quality and philosophical fit with the HIS system. For example, in some embodiments, the HIS may only consider vendors that have a relatively high commitment to continuously reviewing and incorporating member feedback into their service/product design, and/or vendors that are willing to share quality assurance processes and make adjustments as needed to match minimum standards as defined by HIS, and/or vendors that are willing to price products and/or services competitively on the Virtual Shelf, for example.

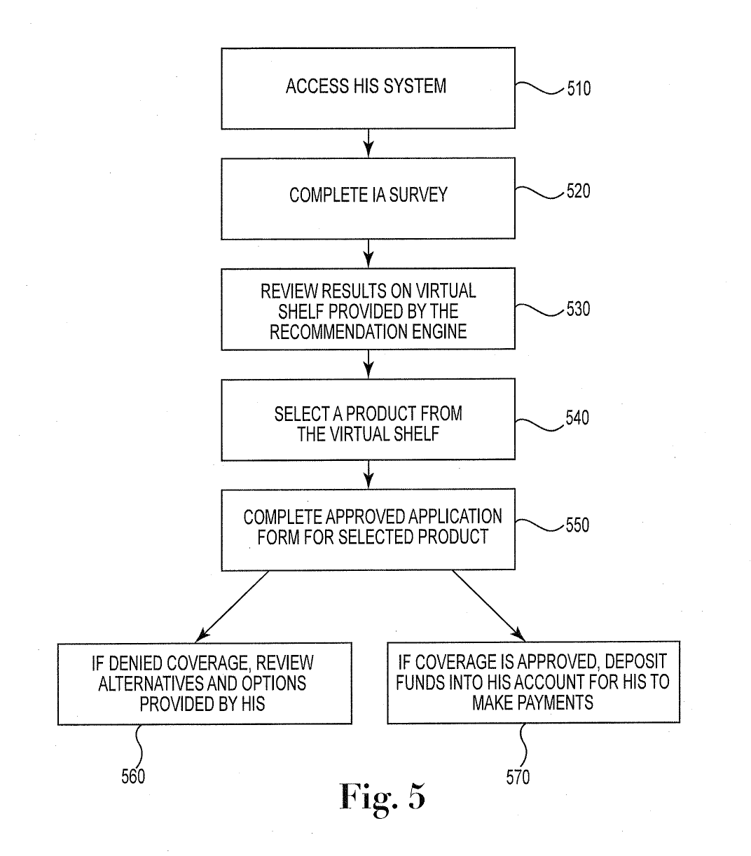

While the embodiments described above were described with regard to an employer/employee member, other embodiments of the present disclosure are possible. For example, in one embodiment an individual may access, register with, and use the HIS system in substantially the same way as described above, in order to purchase health care products and/or services and/or ancillary products and/or services directly. An individual may generally follow the same steps as outlined above and the system may function substantially similarly through to the point where the individual selects a product from the virtual shelf. For example, as shown in FIG. 5, an individual may access the HIS system 510, complete the IA 520, and review results on the Virtual Shelf provided by the HIS recommendation engine 530.

At this point, when the individual selects a product for purchase from the virtual shelf 540, the individual may be requested to complete an application form 550. There may not be a universal form for individuals, but instead, each carrier, and sometimes each product may have a unique application process. The HIS may identify and provide the member with the appropriate application form based on the product the member selected. The form may be provided as a PDF to complete online, or it may be emailed, mailed, or faxed, for example, to the individual member. In some embodiments, the HIS may pre-populate known fields of the application form via the HIS database. For example, the broker, billing address, product chosen, and/or member demographics, for example, may be completed by the HIS system. The HIS may also complete any additional forms the carrier may require, in order to create, for example, an auto pay process. The form may be completed and submitted to the HIS, which may then submit the member application to the designated carrier with the initial payment. The initial payment may be taken from the individual's HIS account, into which the individual may directly deposit funds.

The member and the HIS may be notified of the carrier's decision after some period of time, for example, one-four weeks. Approval/denial criteria and/or the timeframe for notification may vary by carrier. If the carrier denies the member coverage, the HIS may help the member identify and/or navigate any programs available for that member 560. For example, in Minnesota MCHA exists to offer policies for individual health insurance to Minnesota residents who have been turned down for health insurance by the private market, due to pre-existing health conditions. MCHA is sometimes referred to as Minnesota's “high risk pool” for health insurance or health insurance of last resort.

If, however, the carrier approves coverage of the member, HIS may verify the effective date of coverage, the rate of coverage, and/or plan and make adjustments as necessary for payment via the member's HIS account, for example 570. In some embodiments, this may be done by payroll deduction from the member's paycheck to the member's HIS account. In this event, the HIS may also create employer reports to communicate such deductions and product choices, in some embodiments.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

We claim:

1. A method for identifying a product for purchase by an employee based on the employee's circumstances and preferences, the method comprising:
providing a secure web-based system that allows an employer of the employee to register with the system;
allowing the employer to make format selections related to a category of product that the employer makes available to the employee via the web-based system, wherein one of the format selections comprises the amount of money the employer will commit to an employee account set up on the web-based system in order for the employee to purchase an identified product;
allowing the employee of the employer to register with the web-based system;
administering a survey via the web-based system to the employee;
using the results of the survey for the system to identify at least one product that meet criteria of the employee as established by the results of the survey and that meet criteria of the employer as established by the format selections made by the employer; and
permitting the employee to select an identified product for purchase that is paid for by the system via the employee account.

2. The method of claim 1, further comprising providing the employee with a personality profile accessible via the system and that is generated using the results of the survey.

3. The method of claim 1, wherein the category of product that the employer makes available to the employee via the web-based system is a health insurance product.

4. The method of claim 3, wherein the employee account is set up as a health reimbursement account or limited health reimbursement account.

5. The method of claim 3, further comprising coordinating underwriting based on format selections made by the employer.

6. The method of claim 3, further comprising brokering direct sales of the health insurance product to the employee.

7. The method of claim 3, wherein the survey includes questions related to the employee's health, behavior, personality, and financial situation.

8. The method of claim 1, wherein the category of product that the employer makes available to the employee via the web-based system is a wellness education product or service.

9. The method of claim 1, wherein the category of product that the employer makes available to the employee via the web-based system is a vision product or service, life insurance product or service, short-term disability product or service, long-term disability product or service, business travel accident product or service, accidental death and dismemberment product or service, flexible spending account product or service, health savings account product or service, or long term care product or service.

10. The method of claim 1, further comprising allowing the employee to purchase additional products or services via the system if the employee has funds left over in their account after payment is made by the system for the product the employee selected for purchase.

11. The method of claim 1, further comprising providing a member area on the web-based system that allows employers and employees to at least one of provide feedback on the system, and rate the service of the system or product.

12. The method of claim 1, further comprising receiving information about the employee from the employer for input into the system.

13. A method for providing for purchase by an individual at least one health care product that has been specifically selected for the individual, the method comprising:
administering a web-based survey to the individual, the survey providing questions related to at least one of the individual's personality profile, financial profile, or health status, wherein the results of the survey are saved and stored in the web based system;
using the results of the survey as input for the web-based system to run a recommendation engine, wherein the recommendation engine selects at least one health care product for the individual based on at least one attribute of the health care product matching at least one result provided by the individual in response to the survey;
paying for a health care product selected for purchase by the individual from at least one of funds deposited in the account of the individual or the individual's personal funds via the web-based system.

14. The method of claim 13, further comprising providing the individual with an application form to be completed by the individual based on the health care product the individual selects for purchase.

15. A web-based system for providing at least one identified health insurance product or service for purchase by an employee of an employer where the at least one product or service fits criteria provided by the employee and the employer, the system comprising:
a client format selection module permitting an employer to provide the system with format selections, including how much money to deposit into an employee account in order for the employee to purchase a health insurance product via the system;
an intelligent assessment survey module that administers a survey to the employee to determine the employee's preferences and circumstances related to health insurance; and
a recommendation engine module in communication with the intelligent assessment survey module configured to use results of the survey to provide the employee with at least one health insurance product or service for purchase where the at least one identified product or service is based on the results provided by the employee in the survey and format selections provided by the employer.

16. The system of claim 15, further comprising a virtual shelf module in communication with the recommendation engine module, the virtual shelf module configured to provide the employee with the at least one identified health insurance product or service via a web-based application.

17. The system of claim 15, further comprising a personality profile module in communication with the intelligent assessment survey module, the personality profile module configured to provide the employee with a unique health personality profile using the results of the survey via a web-based application.

18. The system of claim 15, further comprising a payment and administration module configured to allow the system to pay for the employee's purchased health insurance product via at least one of the employee's account or the employee's personal funds.

19. The system of claim 15, further comprising a member services module.

20. The system of claim 15, wherein the system is provided via a cloud computing environment.

21. The system of claim 15, wherein the intelligent assessment includes about 20 questions.

22. The system of claim 15, wherein the intelligent assessment includes about 30 questions.

23. The system of claim 15, wherein the intelligent assessment includes from about 40 questions to about 50 questions.
